(19) United States
(12) Patent Application Publication
(10) Pub. No.: US 2015/0354804 A1
(43) Pub. Date: Dec. 10, 2015

(54) OUTDOOR PUBLIC LIGHTING LAMP HAVING LIGHT-EMITTING DIODES AND STREET LAMP OR LAMP-POST PROVIDED WITH SUCH A LAMP

(71) Applicant: Franco MIRABELLI, Luzarches (FR)

(72) Inventor: Franco MIRABELLI, Luzarches (FR)

(21) Appl. No.: 14/759,870

(22) PCT Filed: Jan. 10, 2014
(86) PCT No.: PCT/EP2014/050418

§ 371 Date: Jul. 8, 2015

(30) Foreign Application Priority Data
Jan. 10, 2013 (FR) 13 50224
Jan. 6, 2014 (FR) 14 00009
Jan. 6, 2014 (FR) 14 00010

(51) Int. Cl. F21V 29/83; F21V 29/67; F21V 29/77; H04N 5/222; F21V 33/00; F21V 23/00; F21V 23/02; F21V 15/00; F21S 8/08; F21V 5/04

(52) U.S. Cl. CPC F21V 29/83; F21S 8/086; F21V 29/67; F21V 29/773; F21V 5/04; F21V 33/0052; F21V 23/003; F21V 23/02; F21V 15/00; H04N 5/222; F21Y 2101/02

(57) ABSTRACT

An outdoor public lighting lamp, including an E40 type base, LEDs connected to the base by an electrically conductive circuit and fastened to a support housed in a bulb co-operating with the base to form a sealed enclosure, the support having a tubular radiator with ventilation openings arranged at its ends in order to allow outside air to flow inside the radiator, the bulb being made of a transparent or translucent synthetic material and being partially filled with a liquid that is transparent or translucent and that is electrically insulating, with the LEDs being immersed in the liquid.

A public outdoor lighting device including such a lamp.

The invention relates to an outdoor public lighting lamp of the E40 type and to a lamp post fitted with such a lamp.

### BACKGROUND OF THE INVENTION

At present, outdoor public space (urban spaces, road infrastructures, . . . ) and large commercial or industrial infrastructures (such as production sites or commercial centers) are provided with outdoor lighting systems having incandescent lamps of the E40 type. Such lamps provide considerable light flux, of the order of 30,000 lumens (lm) to 38,000 lm, but they consume a large amount of electricity and they present a maintenance cost that is very high. By way of example, when a hypermarket has 150 E40 bulbs, each consuming an electrical power of 400 watts (W), its annual electricity consumption is about 150 megawatt hours (MWh). In addition, incandescent lamps have a bulb that is made of glass, which is relatively easily broken, and they have a filament with a lifetime of about 12,000 hours (h). Breakages and that relatively short lifetime make it necessary for lamps to be changed relatively frequently, giving rise to maintenance costs that are expensive for public bodies or businesses.

For several years, for home lighting, incandescent lamps have been replaced with so-called “low consumption” compact fluorescent lamps and more recently with lamps having light-emitting diodes (LEDs). Those various types of lamp have enabled significant energy savings to be obtained.

Nevertheless, specifically for E40 lamps for outdoor public lighting, tests have been carried out for replacing incandescent lamps with such new lamps which have not been satisfactory. Although electricity consumption is much lower, such new lamps diffuse much less light than incandescent lamps. For example, an E40 LED lamp is available on the market from SMD, and it consumes 17 W while producing light flux of about 2500 lm, i.e. about one-tenth that of incandescent lamps, which is quite insufficient for outdoor public lighting. Proposals have been made to increase the light flux produced by LED lamps, but any increase in light flux is accompanied by a large rise in temperature in the LEDs, thereby running the risk of the lamp failing or at least of its lifetime being limited. Thus, at present, nearly all lamps for public lighting are still incandescent lamps.

### OBJECT OF THE INVENTION

It would therefore be advantageous to be able to have E40 type lamps available that consume less electricity and that provide light flux equivalent to the light flux produced by incandescent lamps for urban lighting, associated with a lifetime that is relatively long, and while also facilitating maintenance.

### SUMMARY OF THE INVENTION

To this end, the invention provides a lamp having an E40 type base and LEDs placed on a support and connected to the base by an electrically conductive circuit. The support and the LEDs are housed in a sealed enclosure that is formed at least in part by a bulb. The LED support has a tubular radiator with ventilation openings arranged at its ends to allow outside air to flow inside the radiator. The bulb is made of a transparent or translucent synthetic material and it is filled in part with a transparent or translucent liquid, with the LEDs being immersed in the liquid.

The LEDs are thus cooled firstly by exchanging heat by conduction with the radiator, which in turn exchanges heat by convection with the air flowing through it, and secondly by exchanging heat by convection with the liquid.

Preferably, the radiator is provided with internally projecting longitudinal fins.

This serves to increase the heat exchange area between the radiator and the air flowing inside the radiator.

In a preferred embodiment of the invention, the radiator of the lamp is also provided with a forced ventilation device that advantageously comprises at least one fan mounted at at least one of the ends of the radiator, and preferably at each of its ends, i.e. firstly between the base and the radiator, and secondly at the end of the radiator that is remote from the base.

The purpose of the ventilation device is to strengthen the flow of air and thus improve cooling.

In a variant of the invention, the lamp may be provided with a temperature probe that may be housed inside the LED support and that may be connected to a control unit for controlling the ventilation device.

In preferred manner, the LEDs are positioned at regular intervals on each longitudinal face of the support, which is in the form of a regular prism of polygonal section.

The liquid in which the LEDs of the lamp of the invention are immersed is preferably a synthetic oil that is transparent, thermally inert, and electrically insulating.

The lamp is preferably made of transparent polycarbonate.

In a variant of the invention, the lamp is provided with a transformer that may be outside the lamp or that may be incorporated in the LED support.

The invention also provides a public outdoor lighting device comprising a carrier structure with a foot arranged to be suitable for fastening to the ground and a head provided with such a lamp. The device includes a transformer, arranged in the carrier structure in the vicinity of the foot, connecting the lamp to an external source of electricity.

Other characteristics and advantages of the invention appear on reading the following detailed description of a particular non-limiting embodiment of the invention.

### BRIEF DESCRIPTION OF THE FIGURES

The detailed description refers to the accompanying drawings, in which:

FIG. 1 is a diagrammatic longitudinal section view of a lamp of the invention;

FIG. 2 is a diagrammatic view in perspective and in section of the end of the support that houses the ventilation device;

FIG. 3 is a diagrammatic view of a public lighting device of the invention; and

FIG. 4 is a cut-away diagrammatic side view of a lamp in a variant embodiment of the invention.

### DETAILED DESCRIPTION OF AN EMBODIMENT OF THE INVENTION

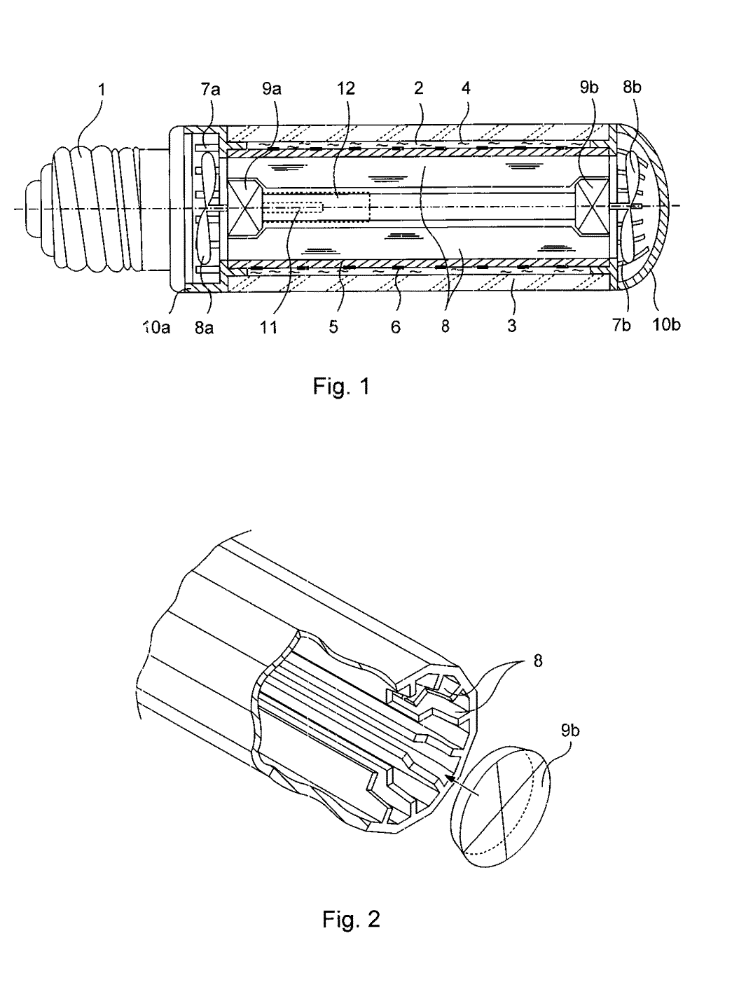

With reference to FIG. 1, the lamp in accordance with the invention comprises base 1 in compliance with the E40 standard and itself known, being provided with electrical conductors (not shown) forming a circuit for electrically powering a light source. It should be recalled that in the name “E40”, the letter E indicates that it is a screw base and the number 40 corresponds to the diameter of the screw in millimeters.

The light source is made up of LEDs 6 that are distributed over a support fastened to the base 1, and placed together in a sealed enclosure 2 formed by a transparent bulb 3 and filled with a transparent or translucent liquid 4. In a particular embodiment of the invention, the length of the support is 200 millimeters (mm).

The support has a tubular radiator 5 that is open at both ends and that is provided at each of said ends with a respective endpiece 10a, 10b having ventilation openings 7a, 7b formed therein that are in communication with the outside.

The radiator 5 may be made of various thermally conductive materials. In this particular embodiment of the invention, the radiator 5 is made of aluminum, which presents high thermal conductivity.

The endpieces 10a and 10b are engaged on the ends of the tubular radiator 5, and the endpiece 10a is also arranged so as to enable the radiator to be fastened to the base 1, e.g. by engaging the base 1 in the endpiece 10a. In preferred manner, the radiator 5 has longitudinal fins 5a projecting inwards. The fins increase the heat exchange area between the support and the air flowing therein so as to enhance the cooling of the enclosure.

The endpieces 10a and 10b serve to fasten the bulb 3 around the radiator 5 and to provide the enclosure 2 with sealing by means of annular gaskets (not shown) that are mounted firstly between the bulb 3 and each of the endpieces 10a, 10b, and secondly between the radiator 5 and each of the endpieces 10a, 10b.

In the presently-described preferred embodiment, the enclosure 2 is cooled in active manner by using at least one forced ventilation device having two fans 8a, 8b, each driven by a respective electric motor 9a, 9b connected to the electrical power supply circuit. The motors 9a, 9b of the fans 8a, 8b are each fastened in a housing arranged within the radiator 5, as shown in FIG. 2. In preferred manner, the lamp of the invention has a fan at each of its ends. The first fan 8a is received in a housing formed in the end of said radiator 5 and is positioned between the radiator 5 and the base 1, and more precisely the adjacent endpiece 10a. The second fan 8b is positioned at the end of the radiator 5 that is remote from the base 1, likewise in a housing formed in said end. In this particular embodiment of the invention, the radiator 5 is thus cooled actively by the two fans 8a, 8b. The person skilled in the art will know how to dimension the ventilation device and how to determine the number of fans needed as a function of the heat given off by the LEDs 6 and the other components of the lamp. The person skilled in the art can also select the fan best suited to the quantity of heat to be dissipated. The speed of rotation of the fans, and the dimensioning and the shape of the blades should all be determined as a function of the quantity of air to be caused to flow in the radiator 5 in order to exhaust the heat produced, and account should also be taken of the noise generated by the fan in operation so as to ensure that the noise in question is maintained at a level that is low enough to avoid inconveniencing pedestrians passing under a lamp post having a lamp of the invention.

The ventilation devices may operate continuously or otherwise. If they do not operate continuously, operation may be triggered when a certain temperature is reached. In an improved version of the lamp of the invention, the lamp is provided for this purpose with a temperature probe connected to a control circuit arranged to switch on the motors of the fans as a function of temperature. The control circuit is incorporated in the lamp. The probe may be placed outside the lamp on the bulb 3, or inside the enclosure in the transparent liquid, or in preferred manner the temperature probe 11 is placed inside the radiator 5.

The radiator 5 forms a regular prism of polygonal section and the LEDs 6 are attached at regular intervals to each of the faces of the radiator 5. In a preferred embodiment, the LEDs 6 are positioned at regular intervals on support strips that are fastened to the faces of the radiator 5. This makes it easier to install the LEDs 6.

The person skilled in the art will know how to select the most appropriate type of LED. In particular, it is preferred to use SMD LEDs having the reference 3535 Flip-Led. In a particular embodiment of the invention, the support has 12 faces each carrying 10 LEDs, giving a total of 120 LEDs providing illumination over 360°. A lamp of this type consumes power of 150 W and produces light flux of about 15,000 lm. In other embodiments of the invention, the power of the lamp, the number of faces of the support, and the number of LEDs may be adapted to the use that is to be made of the lamp. By way of example, the power of lamps in accordance with the invention preferably lies in the range 100 W to 400 W in order to diffuse 10,000 lm to 40,000 lm approximately. Naturally, the number of faces of the support and the number of LEDs should be adapted as a function of the desired power and the desired spatial distribution of lighting, and the same applies to the type of LEDs used, possibly as a function of the shape of the reflector of the lamp post that is to be fitted with the lamp.

As mentioned above, the radiator 5 and the LEDs 6 are housed in a sealed enclosure 2 defined by a bulb 3. The bulb 3 is made of transparent or translucent synthetic material so as to pass all or part of the light spectrum emitted by the LEDs 6. The material used may have a function of filtering certain wavelengths in order to obtain lighting of the desired color (e.g. with a yellow or orange, blue, or white dominant color). By way of example, the person skilled in the art may use polycarbonate or polyvinyl chloride (PVC). The material used must have sufficient resistance to temperature. This resistance to temperature is determined as a function of the cooling device which, by limiting the heating from the LEDs 6, also limits the extent to which the temperature of the bulb is raised, but the material must nevertheless be capable of withstanding that temperature. Finally, the selected material should not degrade over time, given the minimum desired lifetime for the lamp: in particular, it should not change color. In a preferred embodiment, the material used is a polycarbonate that is transparent and stable over time. This material also has the feature of possessing relatively high mechanical strength, in particular against shocks, thus making the lamp very good at withstanding drops and impacts.

In the invention, the bulb 3 is partially filled with a liquid 4 that contributes to cooling the LEDs 6 and the enclosure 2. The liquid used is temperature stable over the temperature ranges encountered while the lamp is in operation, and in this example it does not conduct electricity. Advantageously, it is not toxic for humans and the environment in the event of the bulb breaking, and naturally it is not flammable. Since the LEDs 6 give off heat, the liquid 4 must possess a coefficient of thermal expansion that makes it possible to ensure that the increase of pressure inside the lamp is acceptable. In preferred manner, the liquid 4 that is used is a synthetic oil that is transparent, thermally inert, and electrically insulating. The volume placed inside the enclosure 2 must enable all of the LEDs 6 to be immersed regardless of the orientation of the lamp. The portion of the bulb 3 that does not contain liquid 4 contains air that, by becoming compressed, serves to absorb the increase in volume associated with the expansion of the liquid 4. In the present embodiment, the volume of liquid 4 used represents no more than 90% of the total volume of the enclosure 2. Naturally, the person skilled in the art can adapt the volume of liquid 4 as a function of the size of the bulb 3 used and as a function of the volume occupied by the support of the LEDs 6.

The support strips of the LEDs 6 are made of a material that is preferably thermally conductive, and/or they are arranged so that they do not completely cover the radiator 5, thereby allowing the liquid 4 to exchange heat by convection not only with the LEDs 6, but also with said strips and/or the radiator 5.

The bulb 3 has surfaces that are not plane so that the liquid 4 and the bulb 3 form an optical lens procuring a magnifying glass effect.

By way of example, a lamp of the invention consumes power lying in the range 100 W to 400 W, and preferably 150 W for light flux lying in the range 10,000 lm to 40,000 lm, and preferably 15,000 lm.

The electrical power supply for public lighting requires the presence of a current transformer. In an embodiment of the lamp of the invention, the transformer is outside the lamp. In another embodiment of the invention, the transformer 12 is placed inside the radiator 5.

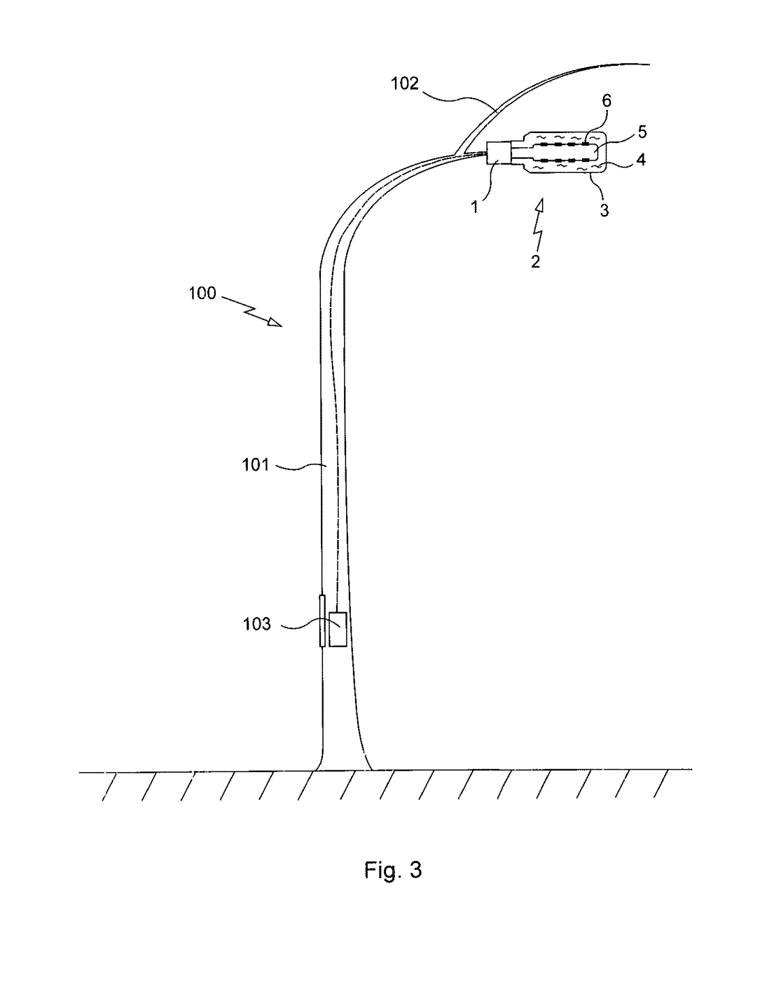

The outdoor public lighting device of the invention as shown in FIG. 3 has a carrier structure 100 comprising a foot 101 arranged to enable it to be secured to the ground, and a head 102 provided with a lamp of the invention. A transformer 103 that is arranged in the carrier structure 100 in the vicinity of the foot 101 connects the lamp to an external electricity supply. The transformer is easily accessible by opening a hatch formed in the carrier structure in register with the housing receiving the transformer.

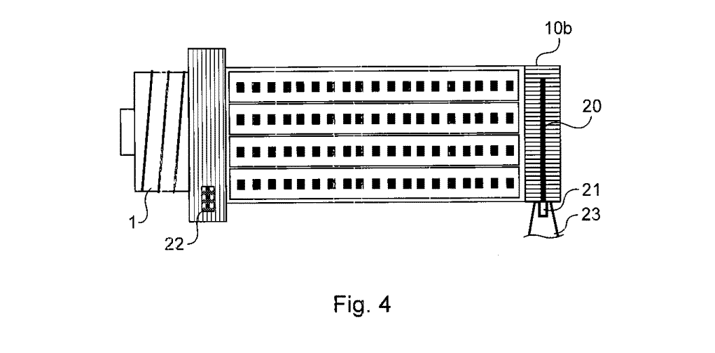

With reference to FIG. 4, and in an improvement of the lamp described with reference to FIGS. 1 and 2, the lamp is fitted with an electronic control circuit 20 that is arranged to manage the operation of the lamp, at least in part, thereby enabling it to be more efficient in its operation. The electronic circuit 20 in this example comprises specifically a processor, a memory, and input/output means enabling it to execute a computer program for controlling the lamp. The electronic circuit 20 in this example also advantageously includes a satellite geolocation module of the global positioning system (GPS) type enabling the electronic circuit to know its geographical position.

The electronic circuit 20 is associated with means for measuring, or merely detecting, operating parameters (current, voltage, . . . ) and/or environmental parameters (temperature, ambient light level, . . . ) associated with the lamp so as to enable the electronic circuit to:
detect whether the lamp has failed or is switched off;
measure how long it has been switched on; and
adapt the intensity of lighting as a function of time or of ambient light conditions.

The electronic circuit 20 is arranged to be capable of being cooled easily. The electronic circuit is installed in the top portion of the bulb and it is cooled by the ventilation device. The control circuit in this example is more particularly arranged on the end of the support remote from the base 1, and more particularly on the endpiece 10b.

Each lamp post in a network of lamp posts is then preferably provided with a lamp having such an electronic circuit. The electronic circuits 20 are then preferably in communication with a remote central control unit comprising, by way of example, a computer executing software for operating lamps. The central control unit may for example be located in a town hall, in the premises of municipal technical services, or in the premises of a body responsible for public works. The operating software is arranged to enable the lamps to operate autonomously (the electronic circuit 20 managing the operation of the lamp as a function of time or of the light detected in the vicinity of the lamp), or in order to cause the lamp to be switched on as a function of the times of sunset and sunrise each day. In addition, the operating software is arranged to issue warnings when the lamps are indicated as failing and to locate them in order to enable maintenance operations to be performed, and in order to constitute a history of lamp operation, based on lamp posts or on geographical zones, . . . .

For this purpose, the electronic circuit 20 includes transceiver means for its connection with the control unit. These transceiver means are arranged to make it possible to send and receive:
data signals (to the control unit);
control signals (from the control unit).

In a first embodiment of these transceiver means, each electronic circuit 20 is connected to the control unit by a wired network dedicated to conveying data and control signals.

In a second embodiment, each electronic circuit 20 is connected to the control unit via the power network (that supplies the power needed for lighting) by means of an interface that superposes the data signals and/or the control signals on the power signal used for powering the lamps.

In a third embodiment, each electronic circuit 20 is connected to the control unit by a wireless network dedicated to transferring data signals and/or control signals. In order to avoid having transceiver means that are too powerful, provision is made for each electronic circuit to be capable of relaying a signal received from an electronic circuit of a neighboring lamp post to a second neighboring lamp post so that the data signals and/or control signals can transit from lamp post to lamp post until they reach a lamp post connected directly to the control unit.

The lamp preferably has a connector for connecting the electronic circuit in such a manner that the electronic circuit can be made available as an option when selling lamps, and can be installed quickly on a lamp if that option is selected, without requiring any intervention other than making the connection.

Among the advantages of the lamp of the invention when fitted with the control circuit, there are the following:
lower consumption;
better management of the stock of lamps;
optimized consumption as a function of season; and
nevertheless conserving sufficient lighting capacity.

In this improvement, another function is added to the lamp. This comprises incorporating a camera function inside the lamp. Given that handling phenomena of urban insecurity now involves ever more frequent deployment of a video surveillance or video protection system, it is found that deploying such a system requires cameras to be installed, which is an operation that is relatively lengthy and expensive. Furthermore, when the cameras are not camouflaged, they can themselves become targets for acts of vandalism.

In the invention, a camera 21, e.g. of the charge-coupled device (CCD) type is incorporated in the lamp in order to capture images and/or take videos.

The camera 21 is preferably a low-noise color camera. In a variant, the camera 21 may be a monochrome camera and/or may be of some other type, such as a complementary metal oxide semiconductor (CMOS) camera. The resolution and the definition of the cameras should be determined as a function of image taking conditions and of the desired image quality. The camera 21 is powered by the lamp via the electronic circuit 20.

In this example, the camera 21 is mounted on the end of the support that is remote from the base 1. The camera 21 in this example is located more precisely on the endpiece 10b.

A video connector 22 is connected to the electronic circuit 20 and is incorporated in the lamp in the vicinity of the base 1 of the lamp in order to deliver the image either in analog mode or in digital mode. The connection between the video connector 22 and the electronic circuit 20 takes place via a flat cable passing through the center of the support.

The camera 21 has a lens for converging light rays of the observed scene onto a sensor proper, so as to project an image of the said scene on the sensor. The lens is movably mounted and associated with an actuator for adjusting focus. An optical filter adapts the light signal to the camera 21.

Preferably, a conically-shaped hood 23 is associated with the camera 21 so as to prevent the light produced by the lamp dazzling the camera 21. The hood 23 will be of shape and length that are determined as a function of the power of the lamp.

Three main applications can be envisaged in particular:

a) in residential areas, the video connector delivers a composite color signal in the PAL/SECAM format that is compatible with monitors available on the market. A coaxial cable enables the video signal to be taken to the monitor;

b) for parking places and roads, the video connector delivers a digital signal in the compressed JPEG format. Under such circumstances, the image may be processed by a remote central computer for remote surveillance applications (e.g. looking for intruders);

c) in stand-alone mode, it is possible to envisage having a video processor incorporated in the electronic card and to perform local processing of the image in order to switch on the lamp in the event of an intrusion, etc.

In a variant, it is possible to provide optical or digital zoom means.

Naturally, the invention is not limited to the embodiment described but covers any variant coming within the ambit of the invention as defined by the claims.

In particular, the support 5 may be of some other shape, for example its shape may be cylindrical, a truncated pyramid, flat, hemispherical, ellipsoidal, . . . .

The bulb is described as being cylindrical, however it could have other shapes, including other surfaces of revolution with or without swellings, e.g. spherical. Convex shapes are preferred so as to enhance the magnifying glass effect obtained with the liquid.

The lamp of the invention has an E40 base. Naturally, the invention applies to lamps having any type of base suitable for use in outdoor public lighting.

The version of the invention with a camera is nevertheless applicable to other public lighting lamps.

The LEDs may all be of the same dimensions or they may be of different dimensions.

The LEDs may all produce the same color or they may produce different colors.

The LEDs are positioned on a support enabling lighting to be provided over 360°, however they could also be placed on a support having a smaller lighting angle. For example, the support may enable lighting to be provided over only 180°.

The electronic control circuit 20 may be carried on a single card, or on a plurality of cards.

1. An outdoor public lighting lamp comprising an E40 type base, LEDs connected to the base by an electrically conductive circuit and fastened to a support housed in a sealed enclosure formed at least in part by a bulb, the lamp herein:
the support has a tubular radiator with ventilation openings arranged at its ends to allow outside air to flow in the radiator; and
the bulb is made of a transparent or translucent synthetic material and is partially filled with a transparent or translucent liquid, in which the LEDs are immersed.

2. The lamp according to claim 1, wherein the radiator has longitudinal fins projecting towards the inside.

3. The lamp according to claim 1, wherein the radiator has at least one forced ventilation device.

4. The lamp according to claim 3, wherein the forced ventilation device comprises at least one fan mounted at one of the ends of the radiator.

5. The lamp according to claim 3, wherein the forced ventilation device comprises a first fan positioned between the base and the radiator, and a second fan positioned at the end of the radiator remote from the base.

6. The lamp according to claim 3, wherein a temperature probe is placed inside the support for the LEDs and is connected to a control unit for controlling the forced ventilation device.

7. The lamp according to claim 1, wherein the support is in the form of a regular prism of polygonal section and wherein the LEDs are positioned at regular intervals on each longitudinal face of said support.

8. The lamp according to claim 1, wherein the bulb is made of transparent polycarbonate.

9. The lamp according to claim 1, wherein the liquid is an oil that is transparent, thermally inert, and electrically insulating.

10. The lamp according to claim 1, including a transformer for powering the LEDs, said transformer being placed remote from the lamp.

11. The lamp according to claim 1, including a transformer for powering the LEDs, said transformer being placed inside the support for the LEDs.

12. The lamp according to claim 1, wherein the liquid and the bulb form an optical lens.

13. The lamp according to claim 1, including an electronic control circuit for managing the operation of the lamp, at least in part.

14. The lamp according to claim 13, including a camera connected to the electronic circuit.

15. The lamp according to claim 14, wherein the camera is mounted at an end of the support remote from the base .

16. The lamp according to claim 14, wherein the electronic circuit is connected to a video connector carried by the base of the lamp.

17. The lamp according to claim 14, including a hood associated with the camera so as to prevent the light produced by the lamp dazzling the camera.

18. The lamp according to claim 14, wherein the connection between the video connector and the electronic circuit takes place via a flat cable passing inside the support.

19. The lamp according to claim 13, wherein the electronic circuit includes a satellite geolocation module.

20. The lamp according to claim 13, wherein the electronic circuit includes transceiver means for connecting it with a remote control unit that is arranged to execute lamp operating software.

21. A public outdoor lighting device comprising a carrier structure having a foot arranged to be secured to the ground and a head provided with a lamp according to claim 1, and a transformer arranged in the carrier structure in the vicinity of the foot, for connecting the lamp to an external supply of electricity.
